(19) United States
(12) Patent Application Publication
(10) Pub. No.: US 2026/0084446 A1
(43) Pub. Date: Mar. 26, 2026

(54) PRINTER AND PLATEN UNIT

(71) Applicant: Roland DG Corporation, Hamamatsu-shi (JP)

(72) Inventors: Ryosuke NONAKA, Hamamatsu-shi (JP); Wataru KAMEDA, Hamamatsu-shi (JP); Shunichi KATO, Hamamatsu-shi (JP)

(21) Appl. No.: 19/332,489

(22) Filed: Sep. 18, 2025

(30) Foreign Application Priority Data
Sep. 25, 2024 (JP) 2024-166704

(51) Int. Cl. B41J 11/06; B41J 11/00; B41J 11/14

(52) U.S. Cl. CPC B41J 11/06; B41J 11/00244; B41J 11/14

(57) ABSTRACT

A printer includes a head that is movable in a scanning direction and configured to eject a liquid onto a medium, a platen extending in the scanning direction to receive the medium placed at a position facing the head, a support extending in the scanning direction to support the platen, a restraint to restrain the platen with respect to the support while allowing sliding of the platen with respect to the support, and a slider interposed between the platen and the support and located at a different position from the restraint.

### CROSS-REFERENCE TO RELATED APPLICATION

The present application claims priority based on Patent Application No. 2024-166704 filed in Japan on Sep. 25, 2024, the entire contents of which are hereby incorporated herein by reference.

### BACKGROUND OF THE INVENTION

### 1. Field of the Invention

Japanese Patent Application Publication Nos. 2013-159059 and 2009-90640 each disclose a printer such as an inkjet printer, the printer including a platen that supports various media, a head configured to eject a liquid such as ink toward the media supported by the platen to print images, and a heater for drying the various media.

### 2. Description of the Related Art

Japanese Patent Application Publication No. 2013-159059 discloses that the platen is supported via an elastic member to reduce or prevent deformation of the platen due to thermal expansion. In a platen support structure described in Japanese Patent Application Publication No. 2013-159059, the platen may be deformed in response to the platen receiving a force from the elastically-deformed elastic member. Japanese Patent Application Publication No. 2009-90640 discloses that the platen is supported in a manner to allow thermal expansion of the platen in a horizontal direction.

A platen support structure described in Japanese Patent Application Publication No. 2009-90640 includes a first support mechanism in which the platen is positioned from below, and a second support mechanism in which the platen is positioned from above, the first support mechanism and the second support mechanism being arranged alternately. Thus, these two types of support mechanisms need to be arranged correctly, which may increase a burden on an operator.

### SUMMARY OF THE INVENTION

Example embodiments of the present invention reduce or prevent deformation of a platen during temperature changes to maintain a planar surface of the platen.

An example embodiment of the present disclosure is a printer including a head that is movable in a scanning direction and configured to eject a liquid onto a medium, a platen extending in the scanning direction to receive the medium placed at a position facing the head, a support extending in the scanning direction to support the platen, a restraint to restrain the platen with respect to the support while allowing sliding of the platen with respect to the support, and a slider interposed between the platen and the support and located at a different position from the restraint.

Other features, elements, characteristics, etc., of the present disclosure will become apparent from the description of example embodiments in the present specification and the accompanying drawings.

According to example embodiments of the present disclosure, it is possible to reduce or prevent deformation of a platen during temperature changes to maintain a planar surface of the platen.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an explanatory view of an overall configuration of a printer 100.

FIG. 2 is a control block diagram of the printer 100.

FIG. 3 is an explanatory view of a transport path of a medium M.

FIG. 4A is a schematic view of a platen unit 30 of the present example embodiment of the present invention.

FIG. 4B is a schematic view of the case where a platen 31 is thermally expanded.

FIG. 4C is another schematic view of the case where the platen 31 is thermally expanded.

FIG. 5 is a perspective view of the platen unit 30.

FIG. 6 is a side view of the platen unit 30 as seen from a right side.

FIG. 7 is a cross-sectional view of a vicinity of a screw 36 to restrain the platen 31 and a support 32.

FIGS. 8A to 8C are perspective views of the support 32.

FIGS. 9A to 9C are perspective views of a support 32 according to a modification of an example embodiment of the present disclosure.

FIGS. 10A and 10B are schematic views according to a comparative example.

### DETAILED DESCRIPTION OF EXAMPLE EMBODIMENTS

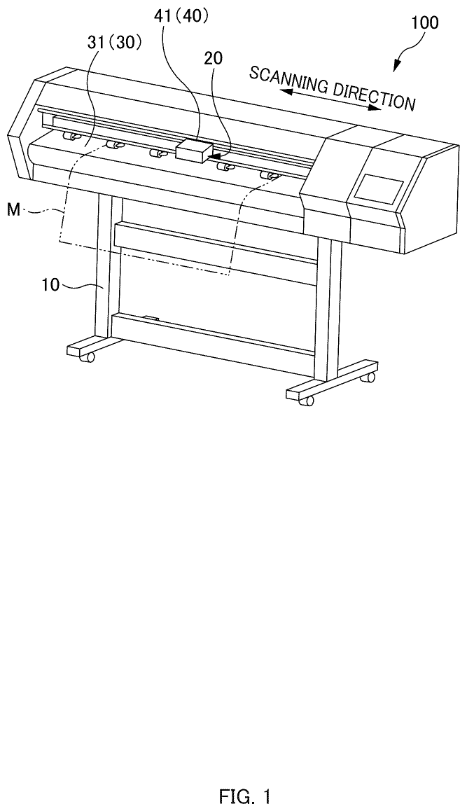

FIG. 1 is an explanatory view of an overall configuration of a printer 100.

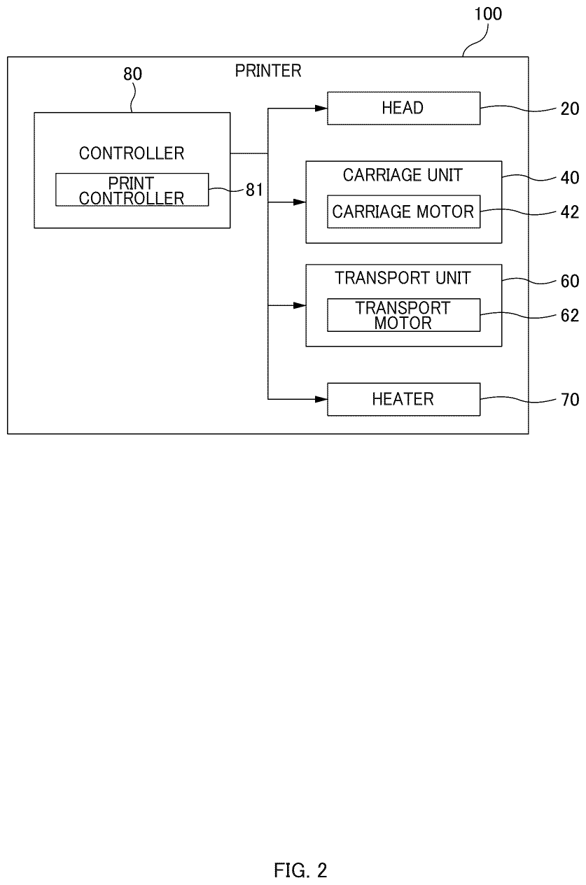

FIG. 2 is a control block diagram of the printer 100.

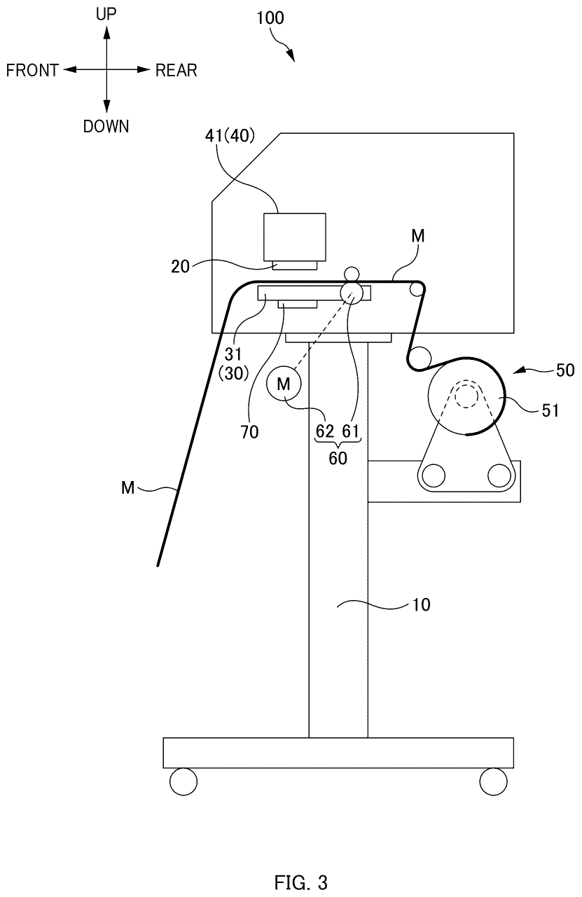

FIG. 3 is an explanatory view of a transport path of a medium M.

In FIG. 3, the transport path of the medium M is indicated by a bold line.

In the following description, directions are defined as illustrated in FIGS. 1 and 3. A direction of movement of a carriage 41 is referred to as a “scanning direction”. The scanning direction may be also referred to as a “left-right direction”, a “width direction”, or a “first direction”. A right side of an operator who operates the printer 100 is referred to as “right”, and a side opposite thereto is referred to as “left”. A vertical direction is referred to as an “up-down direction”. A direction perpendicular to the left-right direction and up-down direction is referred to as “front-rear direction”. The “front” side and “rear” side respectively refer to the operator's side and the opposite side, n from the printer 100. A “transport direction” refers to a direction along the transport path indicated by the bold line in FIG. 3. An “upstream side in the transport direction (upstream side)” refers to a supply side of the medium M (supply unit 50 side). A “downstream side in the transport direction (downstream side)” refers to a discharge side of the medium M. The transport direction may be also referred to as a “sub-scanning direction”.

The printer 100 is an apparatus that performs printing on the medium M. Here, the printer 100 is an inkjet printer that ejects an ink onto the medium. The printer 100 includes a frame 10, a head 20, a platen 31, a carriage unit 40, a supply unit 50, a transport unit 60, a heater 70, and a controller 80.

The frame 10 is a structure that defines a framework (base) of the printer 100. The frame 10 supports other components of the printer 100. For example, a support 32 (described later) that supports the platen 31 is fixed to the frame 10.

The head 20 ejects a liquid (ink) onto the medium M. The head 20 is mounted on the carriage 41 and is movable in the scanning direction. The head 20 ejects, for example, color inks such as cyan, magenta, yellow, and black. A plurality of nozzle rows are provided on a lower surface of the head 20. Here, a region where liquid (ink) is ejected onto the medium may be also referred to as a “printing region”. The printing region is a region facing the nozzle rows of the head 20. Since the ink is ejected from the head 20 moving in the scanning direction, the printing region is an elongated region extending in the scanning direction.

The platen 31 is a structure on which the medium M is placed at a position facing the head 20. In other words, the platen 31 is a structure on which the medium M is placed in the printing region. The platen 31 is a structure having a dimension extending in the scanning direction. Here, the platen 31 is positioned such that a placement surface for placing the medium M thereon is horizontal. However, the placement surface of the platen 31 may be inclined with respect to a horizontal direction. The platen 31 is supported by the support 32 (described later; not illustrated in FIG. 3) that is provided in the frame 10. The heater 70 (described later) is provided on a back surface of the platen 31 and can heat the medium M placed on the platen 31. By heating the medium M in the printing region, the ink is easily fixed onto the medium M.

The carriage unit 40 allows the carriage 41 to move in the scanning direction. The carriage unit 40 includes the carriage 41 and a carriage motor 42. The carriage 41 mounts the head 20 thereon and is movable back and forth in the scanning direction. The carriage 41 is guided in the scanning direction by a guide provided in the frame 10. The carriage motor 42 is a drive source to move the carriage 41. The carriage unit 40 includes a transmission mechanism (such as a gear, pulley, and belt) to transmit a driving force of the carriage motor 42 to the carriage 41. In response to movement of the carriage 41 in the scanning direction by the carriage unit 40, the head 20 moves in the scanning direction.

The supply unit 50 is provided to supply the medium M. The supply unit 50 includes a wound body 51 (such as roll paper) formed by winding the medium M into a roll form. The medium M is drawn from the wound body 51. The supply unit 50 is supported by the frame 10.

The transport unit 60 transports the medium M. The transport unit 60 includes a transporter 61 and a transport motor 62. The transporter 61 is a structure, such as a transport roller, that transports the medium M by rotation. The transporter 61 is located upstream in the transport direction relative to the printing region. The transport motor 62 is a drive source to rotate the transporter 61. The transport unit 60 includes a transmission mechanism (not illustrated; such as gears) to transmit a driving force of the transport motor 62 to the transporter 61. In response to rotation of the transporter 61 by the transport unit 60, the medium M is drawn from the supply unit 50 and conveyed in the transport direction.

The heater 70 is a structure (heat source) to heat the medium M. The heater 70 is provided on the back surface of the platen 31 and heats the medium M placed on the platen 31. The heater 70 heats the medium M in the printing region. The controller 80 is configured or programmed to control the printer 100. The controller 80 includes, for example, an arithmetic processing unit and a storage device (not illustrated). The arithmetic processing unit executes programs stored in the storage device. The arithmetic processing unit of the controller 80 executes the programs stored in the storage device to implement a print controller 81.

The print controller 81 is configured or programmed to cause the printer 100 to execute a printing operation. Specifically, the print controller 81 alternately repeats a dot formation operation and a transport operation. In the dot formation operation, the head 20 moving in the scanning direction ejects ink to form dots on the medium M. In the transport operation, the transporter 61 rotates to transport the medium M in the transport direction. In addition, during printing, the print controller 81 operates the heater 70 to heat the medium M placed on the platen 31.

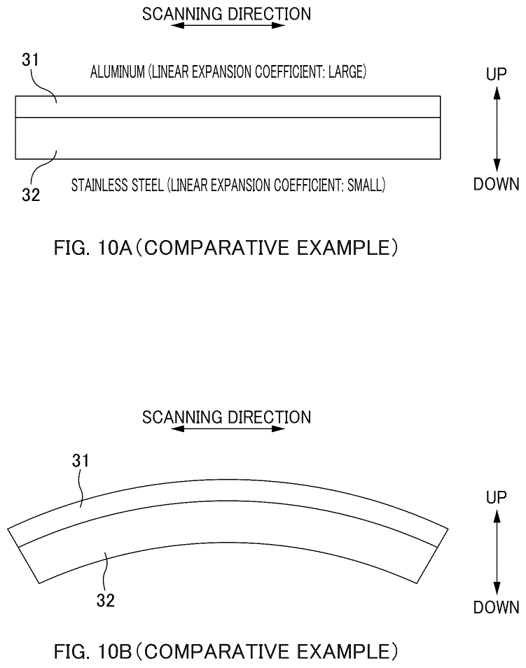

FIGS. 10A and 10B are schematic views according to a comparative example.

In the comparative example, the platen 31 and the support 32 that supports the platen 31 are firmly fixed to each other, and a lower surface of the platen 31 is restrained with respect to an upper surface of the support 32. In such a case where the platen 31 and the support 32 are completely fixed to each other, the platen 31 deforms during temperature changes. For example, in the case where the support 32 is made of stainless steel and the platen 31 is made of aluminum, an increase in temperature may cause the platen 31 to deform convexly upward, in the configuration of the comparative example. This is because the linear expansion coefficient of aluminum is greater than that of stainless steel. Since the platen 31 and the support 32 each have a dimension extending in the scanning direction, their dimensional change amounts in the scanning direction during temperature changes increase. This makes the platen 31 more likely to deform. As a result, a distance between the head 20 and the platen 31 changes depending on positions thereof in the scanning direction, which causes a distance between the head 20 and the medium M to change according to the positions thereof in the scanning direction. This leads to deviation in the ink landing position, resulting in a deterioration of the printed image quality.

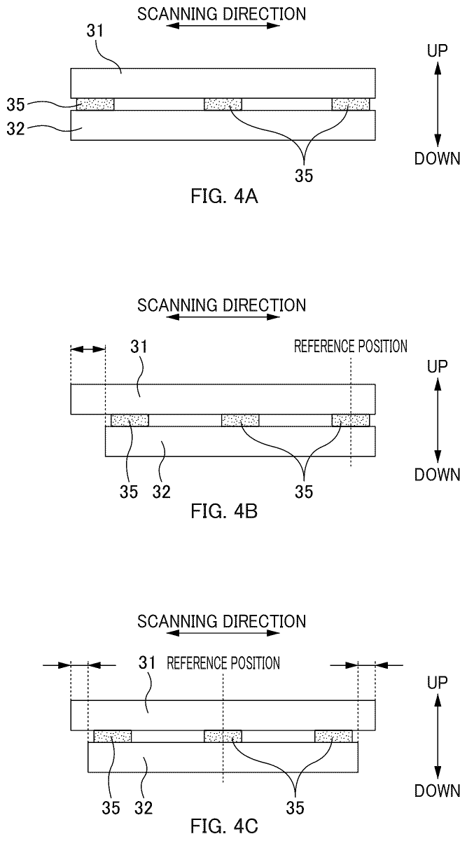

FIG. 4A is a schematic view of the platen unit 30 of the present example embodiment. The platen unit 30 of the present example embodiment includes the platen 31, the support 32, and sliders 35. In the present example embodiment, the sliders 35 are interposed between the platen 31 and the support 32.

The sliders 35 are each a structure that allows movement (sliding; slip) of the platen 31 with respect to the support 32. In other words, the sliders 35 are each a member (slip surface or structure) that facilitates sliding of the platen 31 along a support surface of the support 32. In the following description, a direction along the support surface of the support 32 is also referred to as a “sliding direction”. The sliding direction includes the scanning direction and the transport direction. Since the platen 31 and the support 32 each have a dimension extending in the scanning direction, their dimensional change amounts in the scanning direction during temperature changes increase. Therefore, movement (sliding) of the platen 31 with respect to the support 32, particularly in the scanning direction, is important.

Each of the sliders 35 is preferably sheet-shaped. One surface of each slider 35 is in contact with the platen 31, and the other surface of each slider is in contact with the support 32. Each of the sliders 35, which has a low friction coefficient, reduces friction on a contact surface of the slider 35 with the platen 31 as well as friction on a contact surface of the slider 35 with the support 32. Accordingly, the two structures in contact with each other such as, the slider 35 and the platen 31, and the slider 35 and the support 32, easily slide compared to the case where the platen 31 and the support 32 are in contact with each other. The sliders 35 are each sheet-shaped structures made of fluoroplastic such as Teflon® (registered trademark). However, the material of the sliders 35 is not limited to fluoroplastic.

At least one of the two members including the slider 35 and the platen 31, or the two members including the slider 35 and the support 32, is configured to be slidable. For example, in the case where the sliders 35 are fixed to the platen 31 (for example, when the sliders 35 adhere to the platen 31), the sliders 35 and the support 32 are slidable without fixing the sliders 35 to the support 32. In the case where the sliders 35 are fixed to the support 32 (for example, when the sliders 35 adhere to the support 32), the sliders 35 and the platen 31 are slidable without fixing the sliders 35 to the platen 31. Accordingly, the platen 31 is movable (slidable) with respect to the support 32 in the sliding direction. The sliders 35 need not be fixed to both the platen 31 and the support 32. In this case, the sliders 35 and the platen 31 are slidable, and the sliders 35 and the support 32 are slidable. Also in this case, the platen 31 is movable (slidable) with respect to the support 32 in the sliding direction.

The support 32 supports the platen 31 via the sliders 35. That is, the sliders 35 each have a function of allowing the platen 31 to be movable (slidable) with respect to the support 32 and also have a function of supporting the platen 31. In other words, the sliders 35 each have a function as a sliding bearing (rigid sliding bearing).

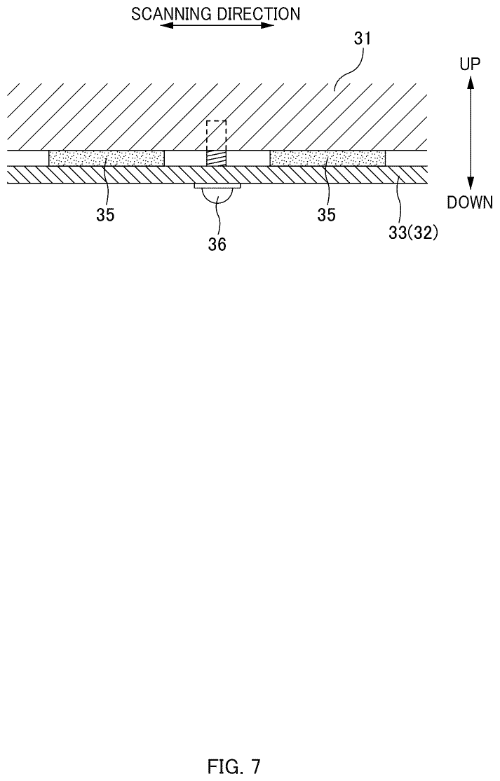

The platen 31 is restrained with respect to the support 32 by a restraint (not illustrated in FIG. 4A; a screw 36 in FIG. 7). The restraint is a structure that restrains the platen 31 with respect to the support 32 while allowing sliding of the platen 31 with respect to the support 32. The provision of the restraint reduces or prevents lifting of the platen 31 from the support 32. The restraint is not limited to the screw 36 described later, as long as the restraint can restrain the platen 31 while allowing sliding of the platen 31. The slider 35 is located at a different position from the restraint, specifically, at a position adjacent to the restraint.

FIG. 4B is a schematic view of the case where the platen 31 is thermally expanded. At a reference position in FIG. 4B, the platen 31 is restrained with respect to the support 32 in the sliding direction. In FIG. 4B, the reference position is located at the right-side end portion. Except at the reference position, the platen 31 is supported movably with respect to the support 32 in the sliding direction. That is, except at the reference position, the platen 31 is not restrained with respect to the support 32 in the sliding direction. For example, in the case where the support 32 is made of stainless steel and the platen 31 is made of aluminum whose linear expansion coefficient is greater than that of stainless steel, the dimensional change amount of the platen 31 is greater than that of the support 32 as the temperature rises. Except at the reference position, the platen 31 moves with respect to the support 32 along the sliding direction (leftward in FIG. 4B, an end portion of the platen 31 slides with respect to the support 32). The end portion of the platen 31 on the side opposite to the reference position moves along the sliding direction (leftward in FIG. 4B) with respect to the support 32 by a distance corresponding to the dimensional change amount. As a result, deformation of the platen 31 can be reduced or prevented. Since the platen 31 slides with respect to the support 32, the platen 31 receives a supporting force (force in the up-down direction) from the sliders 35 without receiving a bending force (bending stress) from the sliders 35. That is, after the platen 31 expands and contracts with respect to the support 32 during temperature changes, the platen 31 does not receive a force that bends the platen 31 from the sliders 35. This can maintain the planar surface of the platen 31.

FIG. 4C is another schematic view of the case where the platen 31 is thermally expanded. In FIG. 4C, the reference position is located in a central portion. In the case where the reference position is located in the central portion, the maximum movement amount (maximum sliding amount) of the platen 31 with respect to the support 32 can be reduced or prevented compared to the case where the reference position is located in the end portion as in FIG. 4B.

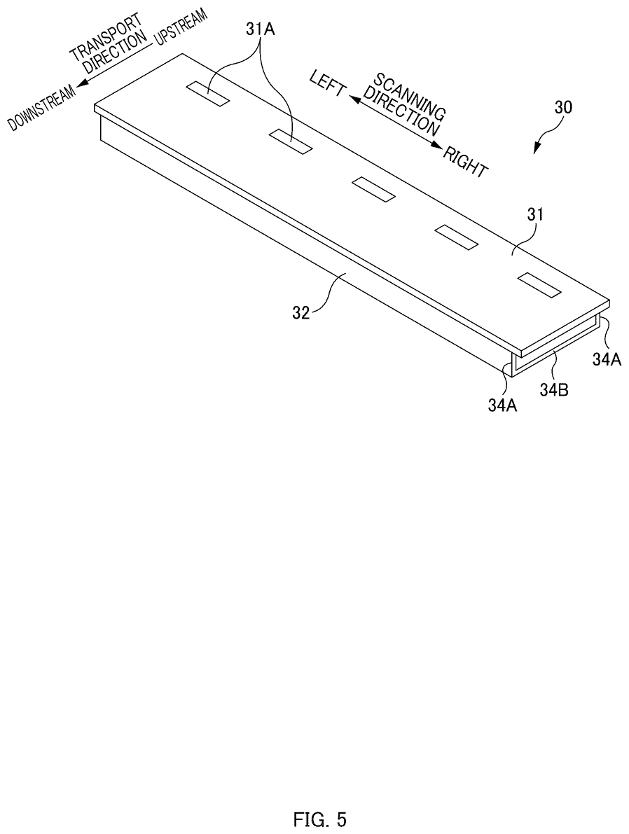

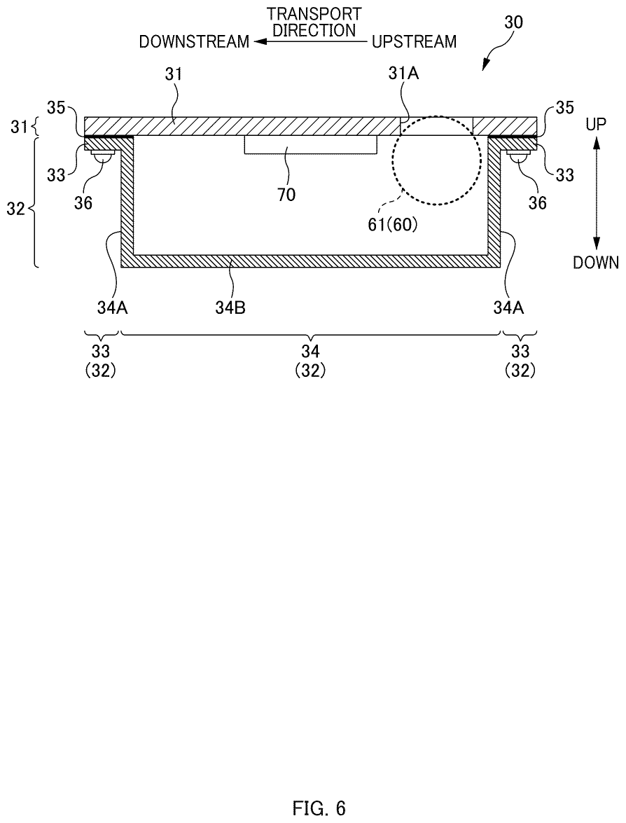

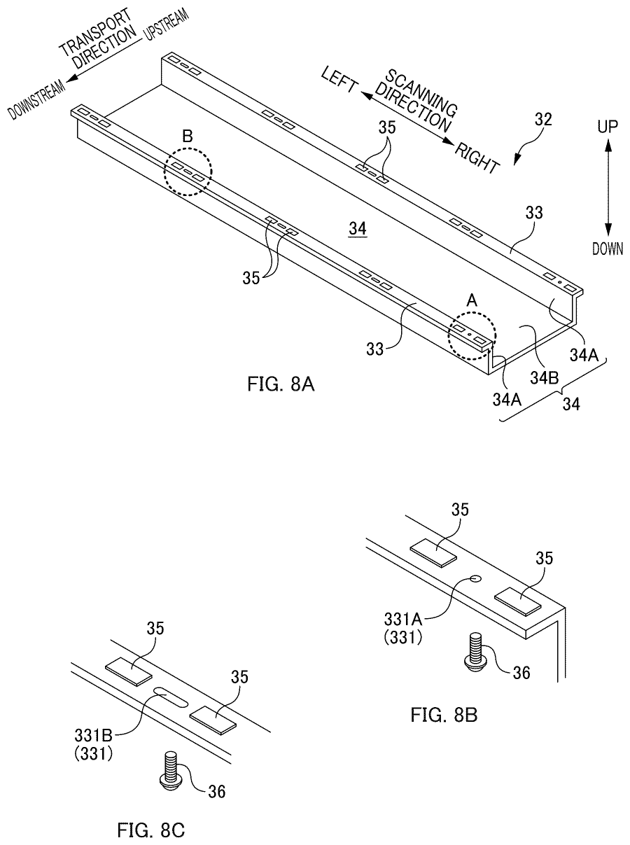

Next, a specific configuration of the platen unit 30 will be described. FIG. 5 is a perspective view of the platen unit 30. FIG. 6 is a side view of the platen unit 30 as seen from the right side. FIG. 7 is a cross-sectional view of a vicinity of the screw 36 to restrain the platen 31 and the support 32. FIGS. 8A to 8C are perspective views of the support 32. FIG. 8B is an enlarged view of a dotted region A in FIG. 8A. FIG. 8B is an enlarged view of the vicinity of an insertion hole 331 (described below; a round hole 331A) at the reference position located in the end portion. FIG. 8C is an enlarged view of a dotted region B in FIG. 8A. FIG. 8C is an enlarged view of the vicinity of an insertion hole 331 (described below; an elongated hole 331B), except at the reference position. The screw 36 is also illustrated in FIGS. 8B and 8C for explanation.

The platen 31 has a dimension extending in the scanning direction, as described above. Here, the platen 31 is made of an aluminum plate. The platen 31 may be made of metal other than aluminum. The dimension of the platen 31 in the transport direction is about 100 mm to about 200 mm, for example. On the other hand, the dimension of the platen 31 in the scanning direction is about 1000 mm to about 2000 mm, for example. In the above-described case where the platen 31 has the dimension extending in the scanning direction, the dimensional change amount of the platen 31 in the scanning direction during temperature changes increases. Thus, it is effective to provide the sliders 35 between the platen 31 and the support 32. The dimension of the platen 31 is not limited to the above-mentioned range.

The heater 70 is provided onto the back surface (lower surface) of the platen 31. The heater 70 heats the platen 31 to heat the medium M to be placed on the platen 31. In the case where the heater 70 is mounted onto the platen 31 as described above, the platen 31 is prone to thermal expansion. Thus, it is particularly effective to provide the sliders 35 between the platen 31 and the support 32. In addition, in the case where the heater 70 is mounted onto the platen 31 as described above, the difference increases in the dimensional change amounts between the platen 31 and the support 32 in the scanning direction. Thus, it is particularly effective to provide the sliders 35 between the platen 31 and the support 32. However, even when the heater 70 is not mounted onto the platen 31, the provision of the sliders 35 between the platen 31 and the support 32 can reduce or prevent deformation of the platen 31 caused by environmental temperature changes. Thus, even when the heater 70 is not mounted onto the platen 31, it is effective to provide the sliders 35 between the platen 31 and the support 32.

Openings 31A are provided in the platen 31 on the upstream side thereof in the transport direction. Each of the openings 31A is a through-hole to expose the transporter 61 (transport roller; see a dotted line in FIG. 6). However, the platen 31 need not have the openings 31A. In this case, the transporter 61 is disposed on the upstream side in the transport direction relative to the platen 31.

The support 32 is fixed to the frame 10 and supports the platen 31 from below. The support 32 is made of sheet metal, for example, and is made of a stainless steel sheet metal herein. However, the support 32 may be made of a metal different from stainless steel. In the case where the linear expansion coefficients of the platen 31 and the support 32 differ from each other, it is particularly effective to provide the sliders 35 between the platen 31 and the support 32. The support 32 includes a support portion 33 and a recessed portion 34. The support 32 is formed by bending the sheet metal, and the support portion 33 and the recessed portion 34 are integrally formed.

The support portion 33 is a portion that supports the platen 31. An upper surface of support portion 33 serves as a support surface to support the platen 31. Thus, the upper surface (support surface) of the support portion 33 is a flat surface parallel or substantially parallel to the lower surface of the platen 31, and is disposed horizontally. The support portion 33 has a dimension extending in the scanning direction. The support portion 33 is made of sheet metal. The sliders 35 are arranged on the support surface. The support 32 is provided with a pair of support portions 33. The pair of support portions 33 are spaced apart from each other in the transport direction. The pair of support portions 33 respectively support upstream and downstream edges of the platen 31 in the transport direction, along the scanning direction. The recessed portion 34 is disposed between the pair of support portions 33.

As illustrated in FIGS. 8B and 8C, each of the support portions 33 includes the insertion holes 331 (round holes 331A and elongated holes 331B) for insertion of the screws 36. Each of the screws 36 is a structure to fix (restraining) the platen 31 to the support 32 in the up-down direction. The insertion holes 331 (round holes 331A and elongated holes 331B) will be described later.

The recessed portion 34 is a portion in which the support portion 33 is recessed relative to the support surface thereof. The recessed portion 34 is a U-shaped portion, and includes a pair of side plates 34A and a bottom plate 34B. The bottom plate 34B is a portion that defines a bottom surface (lower surface) of the recessed portion 34, and is made of sheet metal perpendicular to the up-down direction. The side plates 34A are portions that define the side surfaces (front and rear surfaces) of the recessed portion 34, and are made of sheet metal extending upward from the respective edges of the bottom plate 34B. The support portions 33 are formed by bending from the respective edges of the side plates 34A. The support 32 is fixed to the frame 10 by fixing one of the bottom plate 34B and the side plates 34A to the frame 10. A space is provided between the platen 31 and the recessed portion 34, and in this space, the transporter 61 (transport roller; see the dotted line as illustrated in FIG. 6) and the heater 70 are arranged. The support 32 includes the recessed portion 34 to provide, below the platen 31, the space to accommodate the transporter 61, the heater 70, and the like.

The support 32 may have a flat-plate shape without the recessed portion 34. In this case, the upper surface of the flat-plate-shaped support 32 defines the support portions 33 (support surface) supporting the platen 31.

As illustrated in FIG. 7, the screw 36 restrains the platen 31 and the support 32. This reduces or prevents lifting of the platen 31 from the support 32. The screw 36 restrains the platen 31 with respect to the support 32 so as to restrict movement of the platen 31 with respect to the support 32 in the up-down direction while allowing the sliding of the platen 31 with respect to the support 32 (movement in the direction perpendicular to the up-down direction). The screw 36 is inserted into each of the insertion holes 331 (see FIGS. 8B and 8C) included in the support portion 33 of the support 32. A head portion of the screw 36 is located on the lower surface of the support portion 33, and an end portion of the screw 36 is threaded into a screw hole formed in the platen 31. In this way, the platen 31 and the support 32 are fastened by the screw 36.

As illustrated in FIG. 7, a pair of the sliders 35 is arranged to sandwich the screw 36 in the scanning direction. In other words, as illustrated in FIGS. 8B and 8C, the pair of sliders 35 is arranged to sandwich each of the insertion holes 331 (round hole 331A or elongated hole 331B) in the scanning direction. As a result, the platen 31 can be supported via the sliders 35 on both sides of, in the scanning direction, the position (position of the screw hole) where the platen 31 receives the force in the up-down direction due to tightening of the screw 36 to reduce or prevent deformation of the platen 31 due to tightening of the screw 36.

As illustrated in FIGS. 4B and 4C, at the reference position, the platen 31 is restrained with respect to the support 32 in the sliding direction (mainly in the scanning direction), whereas at positions other than the reference position, the platen 31 is not restrained with respect to the support 32 in the sliding direction. In order to achieve such a configuration, the insertion hole 331 at the reference position is the round hole 331A, and the insertion hole 331 at positions other than the reference position is the elongated hole 331B. The details thereof will be described below.

As illustrated in FIG. 8A, in the support portion 33 of the support 32, the single round hole 331A and a plurality of the elongated holes 331B are arranged along the scanning direction.

As illustrated in FIG. 8B, the insertion hole 331 at the reference position is the round hole 331A. The screw 36 that is inserted through the round hole 331A is restrained with respect to the support 32 (support portion 33) in the scanning direction (and the transport direction). At the reference position, the platen 31 and the support 32 are restrained in the up-down direction and in the scanning direction (and the transport direction) by the screw 36 inserted through the round hole 331A. In other words, at the reference position, the platen 31 is fixed to the support 32, and the platen 31 and the support 32 are positioned in the scanning direction.

As illustrated in FIG. 8C, the insertion hole 331, except at the reference position, is the elongated hole 331B. The elongated hole 331B has a dimension extending in the scanning direction. Except at the reference position, the platen 31 and the support 32 are restrained in the up-down direction (and the transport direction) by the screw 36 inserted through the elongated hole 331B. The screw 36 that is inserted through the elongated hole 331B is allowed to move (slide) in the scanning direction with respect to the support 32 (support portions 33). As a result, except at the reference position, the platen 31 and the support 32 are restrained in the up-down direction (and the transport direction), and movement (sliding) of the platen 31 with respect to the support 32 in the scanning direction is allowed. The elongated hole 331B also has a function to absorb dimensional tolerances of the platen 31 and the support 32 when the screw 36 is inserted into a screw hole (not illustrated) of the platen 31.

In the support 32 illustrated in FIG. 8A, the reference position is located in the end portion as illustrated in FIG. 4B. In this case, the round hole 331A is located in the end portion in the scanning direction. That is, the insertion hole 331 in the end portion (here, the right end) in the scanning direction is the round hole 331A. A plurality of elongated holes 331B are arranged on one side in the scanning direction, as seen from the position of the round hole 331A. For example, the insertion holes 331 in the central portion and the left end in the scanning direction (in other words, the insertion holes 331 other than that in the right end) are each the elongated hole 331B. In some cases, a design reference point is located in the end portion in the scanning direction when the platen 31 and the support 32 each extending in the scanning direction are designed. In such a case, the round hole 331A is located in the end portion in the scanning direction to allow the round hole 331A defining the reference position to be located near the design reference point.

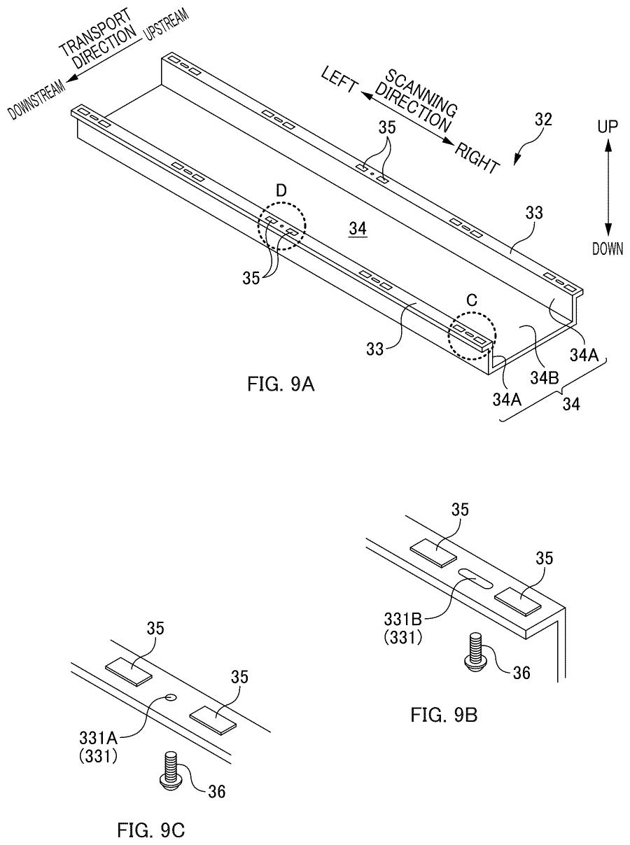

When the reference position is to be located in the central portion as illustrated in FIG. 4C, the round hole 331A is to be located in the central portion in the scanning direction. FIGS. 9A to 9C are perspective views of the support 32 according to a modification of an example embodiment in which the reference position is located in the central portion. FIG. 9B is an enlarged view of a dotted region C in FIG. 9A. FIG. 9B is an enlarged view of the vicinity of the insertion hole 331 (elongated hole 331B) located in the end portion. FIG. 9C is an enlarged view of a dotted region D in FIG. 9A. FIG. 9C is an enlarged view of the vicinity of the insertion hole 331 (round hole 331A) located in the central portion. Similar to FIGS. 8B and 8C, the screw 36 is also illustrated in FIGS. 9B and 9C for explanation.

In the support 32 of the modification, the elongated holes 331B are respectively arranged on one side and the other side of the round hole 331A in the scanning direction. In other words, the elongated holes 331B are arranged on left and right sides of the round hole 331A. Here, as illustrated in FIG. 9B, the insertion hole 331 located in the end portion in the scanning direction is the elongated hole 331B. As illustrated in FIG. 9C, the insertion hole 331 located in the central portion in the scanning direction is the round hole 331A. The insertion hole 331 located in the central portion in the scanning direction serves as the insertion hole 331 that is closest to a position of a central portion of the support 32 in the left-right direction. Thus, the insertion hole 331 located in the central portion in the scanning direction may be slightly shifted from the central portion of the support 32 in the left-right direction. When the round hole 331A is located in the central portion in the scanning direction, the maximum movement amount (maximum sliding amount) of the platen 31 with respect to the support 32 can be reduced or prevented compared to the case where the round hole 331A is located in the end portion in the scanning direction as in FIG. 8A (see FIG. 4C).

As described above, the platen 31 is made of aluminum, the support 32 is made of stainless steel, and the platen 31 is made of the material whose linear expansion coefficient is greater than that of the support 32, for example. In such a case, as illustrated in FIGS. 8A to 8C, it is desirable that, the sliders 35 are fixed onto the support portion 33 of the support 32 via an adhesive or the like in advance, and the platen 31 is supported on the sliders 35 fixed onto the support portion 33. As described above, the sliders 35 are fixed onto the support 32 whose linear expansion coefficient is relatively small to reduce or prevent displacement of the sliders 35 during temperature changes.

The above-described printer 100 includes the head 20, the platen 31 on which the medium is placed at the position facing the head 20, and the support 32 to support the platen 31. The platen 31 and the support 32 each have a dimension extending in the scanning direction, and their dimensional change amounts in the scanning direction during the temperature change increase compared to those in the direction perpendicular to the scanning direction. Thus, when the platen 31 and the support 32 are completely fixed to each other as in the comparative example, the platen 31 may deform during temperature changes (see FIGS. 10A and 10B). To handle such a problem, the above-described printer 100 includes the screw 36 (restraint) to restrain the platen 31 with respect to the support 32 while allowing sliding (movement in the sliding direction) of the platen 31 with respect to the support 32, and the sliders 35 that are interposed between the platen 31 and the support 32 and arranged at different positions from the screw 36. This can reduce or prevent deformation of the platen 31 during temperature changes to maintain the planar surface of the platen 31.

In the above-described printer 100, the linear expansion coefficient of the platen 31 differs from the linear expansion coefficient of the support 32. When the linear expansion coefficients of the platen 31 and the support 32 differ from each other, it is effective to provide the sliders 35 between the platen 31 and the support 32. In the above explanation, the platen 31 is made of aluminum, and the support 32 is made of stainless steel, for example. Then, the platen 31 is made of the material whose linear expansion coefficient is greater than that of the support 32. However, the platen 31 may be made of a material other than aluminum, the support 32 may be made of a material other than stainless steel, and the platen 31 may be made of a material whose linear expansion coefficient is smaller than that of the support 32. Alternatively, the platen 31 and the support 32 may be made of materials having the same linear expansion coefficient. Even in the case where the platen 31 and the support 32 are made of the materials having the same linear expansion coefficient, when the temperatures of the platen 31 and the support 32 differ from each other, the difference occurs in the dimensional change amounts between the platen 31 and the support 32 in the scanning direction. Thus, it is effective to provide the sliders 35 between the platen 31 and the support 32.

As illustrated in FIG. 6, the platen 31 is provided with the heater 70. When the platen 31 is provided with the heater 70, the platen 31 is more likely to be thermally expanded than the support 32. Thus, it is effective to provide the sliders 35 between the platen 31 and the support 32.

As illustrated in FIGS. 8C and 9B, the support 32 includes the elongated hole 331B through which the screw 36 (restraint) is inserted and which extends in the scanning direction. Since the elongated hole 331B allows movement of the screw 36 with respect to the support 32 (support portion 33) in the scanning direction, the screw 36 fixes (restrains) the platen 31 and the support 32 in the up-down direction while allowing movement (sliding) of the platen 31 with respect to the support 32 in the scanning direction.

As illustrated in FIG. 7, the pair of sliders 35 is disposed to sandwich the screw 36 (restraint). In other words, the pair of sliders 35 sandwich the insertion hole 331. This can reduce or prevent deformation of the platen 31 due to fastening with the screw 36.

As illustrated in FIGS. 8A to 8C and FIGS. 9A to 9C, the support 32 includes, as the insertion holes 331, the round hole 331A and the plurality of elongated holes 331B. The round hole 331A and the plurality of elongated holes 331B are arranged along the scanning direction. In some cases, the design reference point is located in the end portion in the scanning direction when the platen 31 and the support 32 extending in the scanning direction are designed.

In such a case, the round hole 331A that defines the reference position can be located near the design reference point by the round hole 331A being located in the end portion in the scanning direction. On the other hand, as illustrated in FIGS. 9A to 9C, in the case where the round hole 331A is located in the central portion in the scanning direction, the maximum movement amount (maximum sliding amount) of the platen 31 with respect to the support 32 can be reduced or prevented compare to the case where the round hole 331A is located in the end portion in the scanning direction as in FIGS. 8A to 8C.

The above-described platen unit 30 includes the platen 31 and the support 32 that supports the platen 31. The platen 31 and the support 32 each have the dimension extending in the scanning direction, and their dimensional change amounts in the scanning direction during temperature changes become greater than those in the direction perpendicular to the scanning direction. Thus, when the platen 31 and the support 32 are completely fixed to each other as in the comparative example, the platen 31 may deform during temperature changes (see FIGS. 10A and 10B). To handle such a problem, the above-described platen unit 30 includes the screw 36 (restraint) that restrains the platen 31 with respect to the support 32 while allowing sliding (movement in the sliding direction) of the platen 31 with respect to the support 32, and the sliders 35 that are interposed between the platen 31 and the support 32 and arranged at different positions from the screw 36. This can reduce or prevent deformation of the platen 31 during temperature changes to maintain the planar surface of the platen 31.

Example embodiments described above are presented as examples, and are not in any way to be construed as limiting the scope of the present disclosure. Configurations described above may be combined as appropriate to be performed, and may be omitted, replaced, and changed without departing from elements, features, etc., of the present disclosure. Example embodiments described above and modifications thereof are included in the scope and the elements, features, etc., of the present disclosure, and also included in the disclosure described in the claims and the scope of its equivalents.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer comprising:
a head that is movable in a scanning direction and configured to eject a liquid onto a medium;
a platen extending in the scanning direction to receive the medium placed at a position facing the head;
a support extending in the scanning direction to support the platen;
a restraint to restrain the platen with respect to the support while allowing sliding of the platen with respect to the support; and
a slider interposed between the platen and the support and located at a different position from the restraint.

2. The printer according to claim 1, wherein a linear expansion coefficient of the platen differs from a linear expansion coefficient of the support.

3. The printer according to claim 1, wherein the platen is provided with a heater.

4. The printer according to claim 1, wherein
the support includes an elongated hole through which the restraint is inserted; and
the elongated hole extends in the scanning direction.

5. The printer according to claim 4, wherein a pair of the sliders sandwiches the restraint.

6. The printer according to claim 5, wherein
the support includes a round hole and a plurality of the elongated holes;
the restraint is inserted through the round hole;
the round hole and the plurality of elongated holes are arranged along the scanning direction; and
the round hole is located in an end portion in the scanning direction.

7. The printer according to claim 5, wherein
the support includes a round hole and a plurality of the elongated holes;
the restraint is inserted in the round hole;
the round hole and the plurality of elongated holes are arranged along the scanning direction; and
the round hole is located in a central portion in the scanning direction.

8. A platen unit comprising:
a platen extending in a scanning direction to receive a medium placed at a position facing a head configured to eject a liquid;
the scanning direction being a direction of movement of the head; and
a support extending in the scanning direction to support the platen;
a restraint to restrain the platen with respect to the support while allowing sliding of the platen with respect the support; and
a slider interposed between the platen and the support and located at a different position from the restraint.
